(19) United States
(12) Patent Application Publication
(10) Pub. No.: US 2026/0189046 A1
(43) Pub. Date: Jul. 2, 2026

(54) Power Station for Trash Container

(71) Applicant: Shi Ping Wang, Ontario, CA (US)

(72) Inventor: Shi Ping Wang, Ontario, CA (US)

(21) Appl. No.: 19/002,978

(22) Filed: Dec. 27, 2024

(51) Int. Cl. H02J 7/00; B65F 1/14

(52) U.S. Cl. CPC H02J 7/855; B65F 1/1421; H02J 7/751; B65F 2210/129

(57) ABSTRACT

A power station for functional trash container includes a high-capacity rechargeable battery pack housed in a housing, a power output terminal unit provided on a docking site and electrically connected with high-capacity rechargeable battery pack, and a power input terminal unit adapted to be provided to a docking surface of the trash container and electrically connected with the high-power demand functional unit of the trash container. When the trash container is docked on power station, the power input terminal unit on the docking surface situated on the docking site of the power station is electrically connected with the power output terminal unit to supply electric power from the high-capacity rechargeable battery pack of the power station to a high-power demand functional unit of the trash container.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to trash container, and more particularly to a power station for functional trash container with higher power demand, which is a docking station configured for a trash container to detachably situate thereto and adapted to supply electric power to the functional units of the trash container.

### Description of Related Arts

As an indispensable household item of human life, trash containers are evolving toward intelligent designs with more advanced functions to accommodate evolving societal needs. However, the integration of advanced functionalities has led to significantly higher consumption, surpassing the capabilities of ordinary batteries and often exceeding the capacity of standard batteries conventionally built-in the induction trash containers. This issue is particularly pronounced in sterilization and deodorization trash containers, which have higher energy demands.

Conventional sterilization and/or deodorization trash containers currently available on the market are equipped with power plugs for electrically connecting to the household power sockets, that significantly limits the trash container to be situated at a location near to a power socket. However, where a household power socket is provided is generally not a location where the user needs to dispose trashes or garbage. In residential or office settings, trash containers are often placed in areas without readily accessible power outlets, resulting in inconvenience and limiting the feasibility of widespread adoption.

To response, rechargeable trash containers have been introduced and are gaining broader adoption. For examples, U.S. Pat. No. 7,911,169 discloses an induction actuated container, US20200291940 discloses an artificial intelligent trash container with sanitary and health control, and U.S. U.S. Pat. No. 12,084,277 discloses a sterilization and deodorization waste bin, which batteries for power supply to the induction unit, operation unit and the motorized unit are housed in the induction actuated container cover. U.S. Pat. No. 8,872,459 discloses a trash can with variable gearing assembly which batteries are housed in a back side enclosure.

Despite this, most rechargeable trash containers are equipped with batteries of limited capacity, necessitating frequent recharging, especially for the sterilization and/or deodorization trash containers with high power consumption. The frequent need for recharging forces the users to stop using trash containers during the charging from time to time, that results in a suboptimal user experience. To mitigate this issue, some conventional sterilization and/or deodorization trash containers minimize the sterilization and/or deodorization cycles, operating only once every 24 hours for about ten minutes, which fails to achieve a good sterilization and/or deodorization effect.

### SUMMARY OF THE PRESENT INVENTION

The invention is advantageous in that it provides a power station for functional trash container with high-power demand, which is configured as a docking site for the functional trash container to detachably situate thereto and adapted to supply electric power to the functional units of the trash container.

Another advantage of the invention is to provide a power station for functional trash container which comprises a power output terminal unit provided on a docking site and a power input terminal unit adapted to be mounted on a docking surface of the functional trash container and electrically connected to the functional units thereof, such that when the functional trash container is docked on the power station, the power input terminal unit is electrically connected with the power output terminal unit so that the rechargeable batteries housed in the power station can supply electric power to the functional units of the functional trash container.

Another advantage of the invention is to provide a power station which is configured to allow a functional trash container to fittingly dock thereon while ensuring a fully electrical connection between the power station and the functional trash container.

Another advantage of the invention is to provide a power station which is configured a docking station for the functional trash container situated thereon, such that the weight of the rechargeable batteries housed therein forms a stable base to prevent the functional trash container, such as a sterilization and/or deodorization trash container, from tipping over or being moved inadvertently.

Another advantage of the invention is to provide a power station for functional trash container, wherein when the functional trach container, such as a sterilization and/or deodorization trash container, is required to be thorough clean, the user may simply detach the functional trash container from the power station without lifting and moving the heavy batteries contained in the power station. In addition, since the power supply batteries are not housed in the trash container, the cleaning of the trash container can perfectly prevent the batteries from getting wet, that may result in rapid discharge and potential overheating and damages of the batteries as well as corrosion and internal chemical leakage of the batteries. Especially, to the lithium-ion or lithium polymer batteries, water can cause internal short circuits, leading to overheating, fire or even explosions due to phenomenon called thermal runaway.

Another advantage of the invention is to provide a power station for functional trash container, wherein functions such as induction opening and closing of the lid, sterilization and deodorization of the trash container can be continuously functioned. The shortcoming of the conventional functional trash container that the trash container has to pause its functions while charging its batteries is substantially overcome. In other words, there is no battery recharging time required for the present invention. The user may simply situate the functional trash container to another fully charged power station at the same location. The drained power station alone can be moved to any desired location to recharge. It is especially convenient for trash container to be used in kitchen or dining area such as restaurant or café where no electrical power socket is available.

Another advantage of the invention is to provide a power station for functional trash container, in which the rechargeable batteries are housed in the power station and no battery is contained in the trash container. Since the power station is physically isolated from the receiving chamber of the trash container that may contain liquid waste, wet trash and organic waste, the risk of charging web batteries is avoided.

Another advantage of the invention is to provide a functional trash container configured to equip with at least one power station in a detachable manner for supplying electric power to the functional units thereof.

Another advantage of the invention is to provide a power station for a functional trash container comprising an induction sensor unit for controlling the opening and closing of a lid of the trash container and a sterilization and/or deodorization apparatus built-in, wherein the lower power demanded induction sensor unit is powered by one or more rechargeable batteries housed in the container cover where the induction sensor unit being installed, and the high power demanded sterilization and/or deodorization apparatus is powered by the power station to which the trash container is equipped therewith or detachably docked thereon.

Another advantage of the invention is to provide a power station for a functional trash container, wherein the power station is configured to be electrically connected with one or more functional units of the trash container when the power station is installed to the trash container and electrically disconnected with the one or more functional units of the trash container when the power station is detached from the trash container.

Another advantage of the invention is to provide a functional trash container equipped with a power station, wherein the power to the low-power demand function unit such as the induction circuit and high-power demand functional unit such as the sterilization and/or deodorization unit are supplied and managed independently to meet the demand and efficiency of use.

Another advantage of the invention is to provide a power station for a functional trash container which is configured with one or more movable elements for ease of ground transportation.

Additional advantages and features of the invention will become apparent from the description which follows and may be realized by means of the instrumentalities and combinations particular point out in the appended claims.

According to the present invention, the foregoing and other objects and advantages are attained by a power station for a trash container which comprises a low-power demand functional unit, such as an induction circuit for operating an opening and a closing of a lid of the trash container, and a high-power demand functional unit such as a sterilization and/or deodorization apparatus built in the trash container, wherein the power station comprises:
a housing defining a station chamber therein and having a docking site on one side thereof adapted for a docking surface of the trash container docking thereto;
a high-capacity rechargeable battery pack, including a plurality of rechargeable batteries, being housed in the station chamber of the housing;
a control unit housed in the power chamber and configured to control the charging and discharging electric power of the plurality of rechargeable batteries, and converting a low voltage power of the plurality of rechargeable batteries to a high voltage power adapted for powering the high-power demand functional unit;
a power supply terminal electrically connected with the plurality of rechargeable batteries and the control unit for selectively connecting with an external power supply to charge the plurality of rechargeable batteries;
a power output terminal unit provided on the docking site and electrically connected with the plurality of rechargeable batteries and the control unit; and
a power input terminal unit adapted to be installed to the docking surface of the trash container and electrically connected with the high-power demand functional unit of the trash container, such that when the trash container is docked on power station, the power input terminal unit on the docking surface situated on the docking site of the power station is electrically connected with the power output terminal unit to supply electric power from the plurality of rechargeable batteries of the power station to the high-power demand functional unit of the trash container, and that when the trash container is detached from the power station, the power output terminal unit and the power input terminal unit are disconnected.

In one embodiment, the trash container may comprise one or more rechargeable batteries to supply power to the low-power functional unit.

In one embodiment, the power station further comprises one or more movable elements configured for facilitating a ground transportation of the power station.

In one embodiment, the one or more movable elements of the power station is embodied as one or more rollers rotatably installed to a side or a bottom of the power station.

In one embodiment, the power station further comprises a docking alignment unit configured to fittingly situate the docking surface with the docking site and precisely align the power output terminal unit with the power input terminal unit to ensure precise and fully electrical connection therebetween.

In one embodiment, the power input terminal unit also electrically connected with the low-power demand functional unit of the trash container and the plurality of rechargeable batteries of the high-capacity rechargeable battery pack also supplies electrical power to the low-power demand functional unit.

In one embodiment, a low-capacity battery pack, including at least one battery, is provided in the trash container to supply electrical power to the low-power demand functional unit of the trash container while the power station supplies electrical power to the high power demand functional unit of the trash container via the power output terminal unit and the power input terminal unit. The advantage of this embodiment is that when the power station is drained, the user may simply detach the trash container from the power station and move the drained power station to recharge through the power supply terminal unit. In the meanwhile, the low-power demand functional unit, such as the induction circuit and the lid opening and closing device, is still functioning due to the continuous power supply by the low-capacity battery pack. The user may replace a fully charged power station to the same location for the trash container docking thereon to continue the power supply to the high-power demand functional unit of the trash container.

In one embodiment, the trash container is adapted to situate on the power station which forms a stable base for the trash container, wherein the shape and size of the docking site of the power station matches the shape and size of the docking surface which is the bottom surface of the container body of the trash container.

In one embodiment, the trash container further comprises a container base provided underneath the container body of the trash container, wherein the container base has a station slot shaped and sized to allow the power station fittingly embedded therein. Further, the docking site of the power station is provided on a rear side thereof and docking surface forms at a rear end surface of the station slot, such that when the power station is embedded in the station slot, the docking site docks against the docking surface and ensures the power output terminal unit provided on the docking site fully connected with the power input terminal unit provided on the docking surface of the container base of the trash container.

In one embodiment, the connection between the power output terminal unit and the power input terminal unit is a protrusion and indention fitting connection, that not only facilitates an alignment of the connection between the power output terminal unit and the power input terminal unit, but also ensures a secure and stable electrical connection between the power output terminal unit and the power input terminal unit.

In one embodiment, the power station further comprises a trigger switch provided on the docking site thereof for controlling an output of the plurality of rechargeable batteries via the power output terminal unit and configured in such a manner that only when both the power input terminal unit at the docking surface of the trash container is correctly connected with the power output terminal unit and the trigger switch is actuated to send a trigger signal, the plurality rechargeable batteries of the rechargeable battery pack is activated to supply electric power to the trash container to ensure a safety of the use of the rechargeable battery pack. Without the actuation of the trigger switch, even if the power output terminal unit of the power bank detached from trash container is in contact with an electrical conducting material, no electric power will be supplied.

In one embodiment, both the power output terminal unit and the power input terminal unit are configured in circular configuration so as to ensure an effective electric connection between the power output terminal unit and the power input terminal unit due to the weight of the trash container.

In one embodiment, the power station will only supply electric power when the docking surface of the trash container is correctly docked on the docking site of the power station.

In one embodiment, the power station further comprises at least one positioning member protruded on the docking site thereof and, correspondingly, at least one positioning groove is formed in the docking surface of the trash container, so as for guiding and aligning the docking surface to dock on docking site of the power station precisely when the trash container situates on the power station to ensure good and effective connection of the power output terminal unit and the power input terminal unit.

In one embodiment, the power supply terminal unit is a power socket to ensure safety during charging of the high-capacity rechargeable battery pack.

In one embodiment, the power station also charges the low-power battery contained in the trash container while the power output terminal unit and the power input terminal unit are electrically connected. Therefore, no additional power supply terminal is required to be provided by the trash container to charge the low-power battery.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a trash container equipped with a power station according to a preferred embodiment of the present invention.

FIG. 2 is a partial exploded perspective view of the trash container and the power station according to the above preferred embodiment of the present invention.

FIG. 3 is an exploded perspective view of the trash container according to the above preferred embodiment of the present invention.

FIG. 4 is a partial sectional view of the trash container according to the above preferred embodiment of the present invention.

FIG. 5 is a perspective view of the power station according to the above preferred embodiment of the present invention.

FIG. 6 is an elevational view of a docking surface of the trash container according to the above preferred embodiment of the present invention.

FIG. 7 is an exploded view of the power station according to the above preferred embodiment of the present invention.

FIG. 8 is a perspective view of a trash container equipped with a power station according to a first alternative mode of the above preferred embodiment of the present invention.

FIG. 9 is a partial exploded perspective view of the trash container and the power station according to the first alternative mode of the above preferred embodiment of the present invention.

FIG. 10 is a partial perspective view illustrating the docking surface of the trash container according to the first alternative mode of the above preferred embodiment of the present invention.

FIG. 11 is a front perspective view of the power station according to the first alternative mode of the above preferred embodiment of the present invention.

FIG. 12 is a rear perspective view of the power station according to the first alternative mode of the above preferred embodiment of the present invention.

FIG. 13 is an exploded view of the power station according to the first alternative mode of the above preferred embodiment of the present invention.

FIG. 14 is a perspective view of a trash container equipped with a power station according to a second alternative mode of the above preferred embodiment of the present invention.

FIG. 15 is an exploded perspective view of the trash container and the power station according to the second alternative mode of the above preferred embodiment of the present invention.

FIG. 16 is an exploded perspective view of the power station according to the second alternative mode of the above preferred embodiment of the present invention.

FIG. 17 is a circuit block diagram of the power station for functional trash container according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

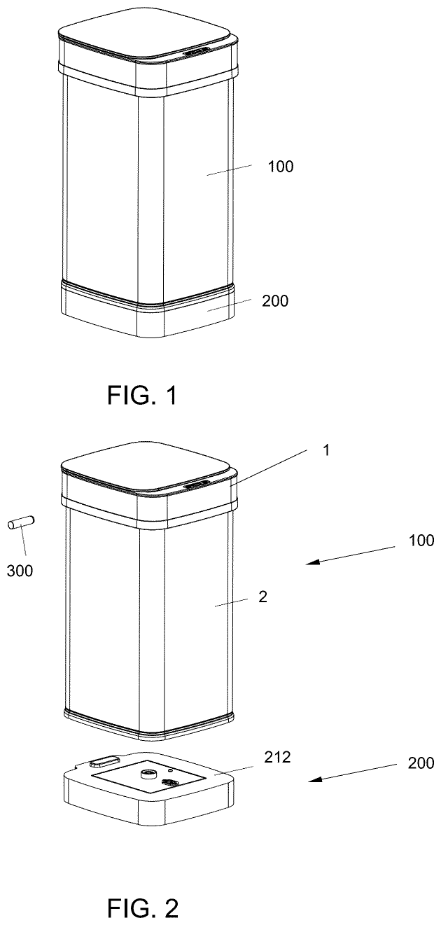

Referring to FIG. 1 to FIG. 7, a trash container 100 and a power station 200 configured to equip with the trash container 100 according to a preferred embodiment of the present invention are illustrated. The trash container 100 is embodied as a functional trash container comprises at least one low-power demand functional unit and a high-power demand functional unit.

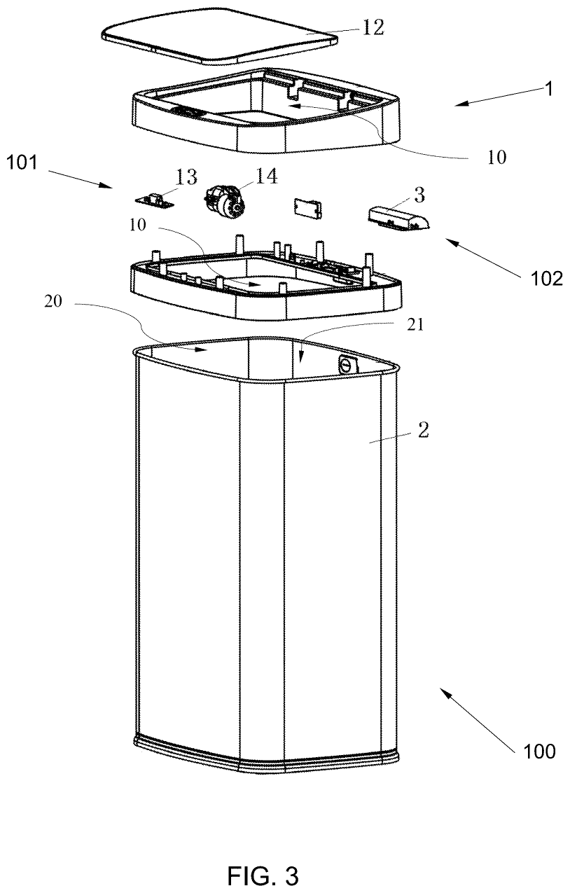

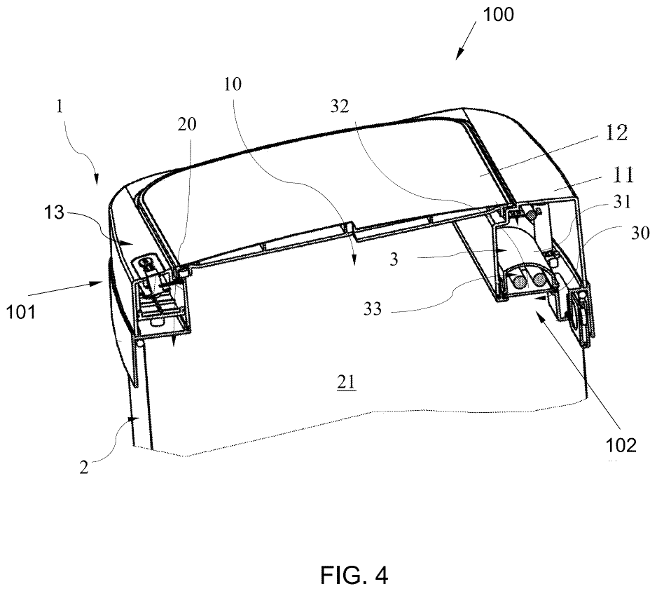

As shown in FIG. 1, FIG. 3 and FIG. 4, the trash container 100 is embodied as a functional trash container such as a dual-band ultraviolet sterilization and deodorization induction trash container as disclosed in a U.S. patent application, publication number US20240390534, which includes a container lid 1, a container body 2. The container body 2 has an inner cavity 21 adapted for storing waste and a container opening 20 communicating the inner cavity 21 with outside. The container lid 1 comprises a circular housing 11 provided at a top edge of the container body 2 and a lid 12 pivotally connected to the circular housing 11, such that the lid 12 is pivotally couple at a container opening 20 above the container body 2 to be moved selectively between an open state to expose the inner cavity 21 to outside through the container opening 20 and a close state to cover the container opening 20 and close the inner cavity 21 from outside.

The circular housing 11 is a ring shape member mounted on the top edge of the container body 2 and the lid 12 is hinged to the container opening 20 in the top of the container body 2. An isolation chamber 3, which is a reflector housing 31 having an isolation cavity 30 defined therein, isolated from the air outside is arranged below the container lid 1.

The high-power demand functional unit of the trash container 100 can be embodied as a sterilization and deodorization apparatus arranged in the isolation chamber 3. A light-transmitting widow 32 is formed below the isolation chamber 3. Due to the harsh environment of the waste container, the dual-band ultraviolet lamp tube 33 is a U-shaped dual-band ultraviolet tube and arranged in the isolation cavity 30 of the air-isolated isolation chamber 3.

The sterilization and deodorization apparatus comprises a dual-band ultraviolet lamp tube 33 generates ultraviolet light rays, with 254 nm wavelength and 185 nm wavelength, irradiated into the waste container through the light-transmitting window 32, preferably made of the transparent quartz glass, so as to use the ultraviolet light rays for sterilization and deodorization. In which, the ultraviolet light wave with 254 nm wavelength (also known as short-wave sterilization ultraviolet) has a higher photon energy, that can penetrate cell membranes and nucleus of microorganisms, destroy the molecular bonds of their DNA, and make them losing replication ability or activity and die while irradiating microorganisms. Also, the irradiating of the ultraviolet light wave with 185 nm wavelength in the air can turn O2 (oxygen) in the air into O3 (ozone). Ozone, which has a strong oxidation effect, can effectively kill bacteria. The diffusion and dispersion ability of ozone fitly make up for the shortcoming of ultraviolet that only propagates along a straight line and has dead angles and corners for disinfection. Since the container lid 1 is mounted on the container body 2, the isolation chamber 3 is preferred to be positioned at or above the container opening 20 in such a manner that the ultraviolet light rays generated by the dual-band ultraviolet lamp tube 33 irradiated all positions in the inner cavity 21 of the container body 2 through the light-transmitting window 32.

The low-power functional unit 101 of the trash container 100 can be embodied as an automatic driving arrangement as disclosed in U.S. patent number U.S. Pat. No. 7,911,169, which includes an induction circuit 13 and a lid opening and closing diving device 14 arranged in the container lid 1. The induction circuit 13 comprises an infrared sensor configured to be activated with respect to the target movement, the lid opening and closing driving device 14 generates a decelerating and torque enhancing force to pivotally move the lid 12 at the opened position that the container opening 20 faces towards an approaching direction of the user for allowing the user to access the inner cavity 21 of the container body 2.

The power supply requirement for such low-power demand functional unit as the induction circuit 13 is about 3.3V to 5V DC with low current consumption (10 mA to 15 mA), wherein electrical power is merely consumed when a person is detected within a detection range to drive the lip 12 to open. Generally, one or two rechargeable D or C batteries is capable of supplying enough power for the induction circuit 13 and the lid opening and closing device 14 to work for months.

However, the power supply for the high-power demand functional unit 102 as the dual-band ultraviolet lamp type sterilization and deodorization apparatus is about 5V to 12V DC with 200 mA to 600 mA current consumption, wherein the power consumption is up to 10 W to 15 W for the mercury-based dual-band ultraviolet lamp. Also, the sterilization and deodorization apparatus is required to continuously consume stable power to generate ultraviolet light rays while the lip 12 is closed.

For example, in order to continue supply electric power to the sterilization and deodorization apparatus embodied above while the lid 12 is closed for a week, approximately sixty or more lithium-ion batteries (3.7V, 2600 mAh), each having energy capacity of 9 to 10 Wh, are required to supply about 1000 Wh per only a week. Therefore, it is too heavy and not feasible to contain so many batteries in the container lid 1 or the container body 2. Therefore, most conventional sterilization and deodorization trash containers are provided with electric cables and AC/DC converters to connect to the wall power socket for stable power supply, that limits the trash container to only be placed at a location adjacent to a wall power socket. However, anywhere people may dispose liquid, wet and organic wastes, such as outdoor dining area without AC power supply, desires a sterilization and deodorization trash container to ensure a sanitary environment.

The power station 200 of the present invention provides a solution to such high-power demand functional trash container 100. Referring to FIG. 1 and FIG. 2, the power station 200 according to the preferred embodiment of the present invention comprises a housing 210, a high-capacity rechargeable battery pack 220, a control unit 230, a power supply terminal 240, a power output terminal unit 250, and a power input terminal unit 260.

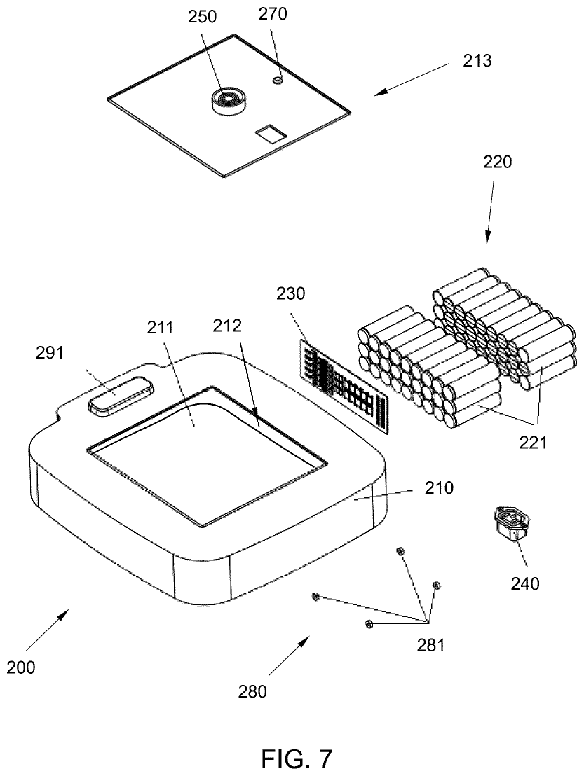

Referring to FIG. 7, the housing 210, preferred having a shape and size similar to a shape and size of a docking surface 110 which is embodied as a bottom surface of the container body 2 of the trash container 100, has a station chamber 211 defined therein and a docking site 212 formed on one side thereof adapted for the docking surface 110 of the trash container 100 docking thereto. The high-capacity rechargeable battery pack 220 includes a plurality of rechargeable batteries 221 housed in the station chamber 211 of the housing 210.

The control unit 230 is housed in the power chamber 211 and configured to control the charging and discharging electric power of the plurality of rechargeable batteries 221, and converting a low voltage power of the plurality of rechargeable batteries 221 to a high voltage power adapted for powering the high-power demand functional unit 102. When charging the power station 200, the control unit 230 is configured to convert the AC power from the power supply terminal unit 240 which has connected with an external AC power supply to DC power and charge the plurality of rechargeable batteries 221.

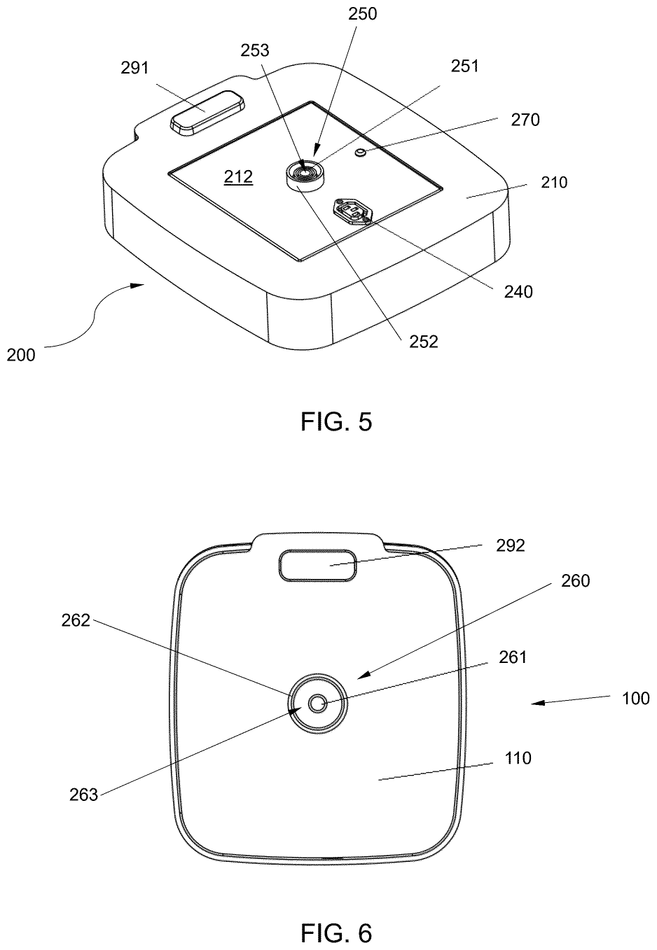

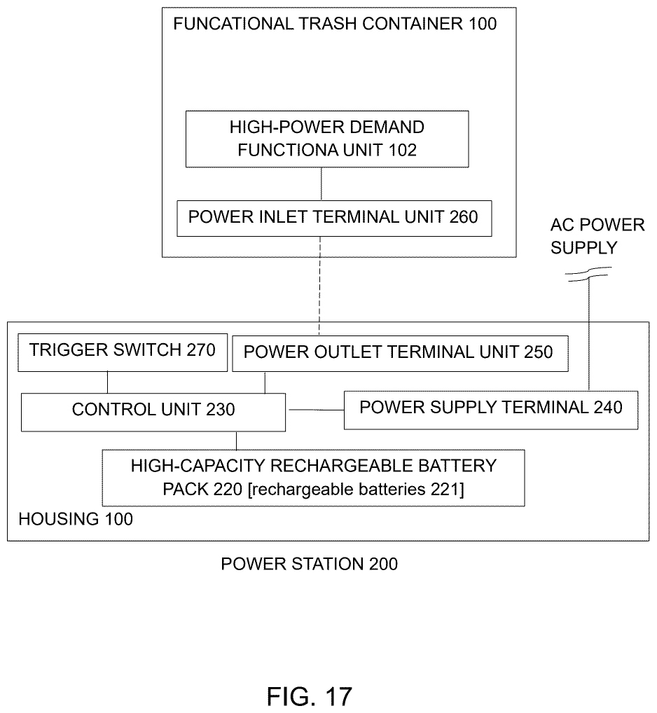

Referring to FIG. 5 and FIG. 17, the power supply terminal 240 is electrically connected with the plurality of rechargeable batteries 221 of the high-capacity rechargeable battery pack 220 and the control unit 230 for selectively connecting with an external power supply AC to charge the plurality of rechargeable batteries 221.

Referring to FIG. 5, FIG. 6 and FIG. 17, the power output terminal unit 250 is provided on the docking site 212 and electrically connected with the plurality of rechargeable batteries 221 and the control unit 230. The power input terminal unit 260 is adapted to be installed to the docking surface 110 of the trash container 100 and electrically connected with the high-power demand functional unit 102 of the trash container 100, such that when the trash container 100 is docked on power station 200, as shown in FIG. 1, the power input terminal unit 260 on the docking surface 110 situated on the docking site 212 of the power station 200 is electrically connected with the power output terminal unit 250 to supply electric power from the plurality of rechargeable batteries 221 of the power station 200 to the high-power demand functional unit 102 of the trash container 100, and that when the trash container 100 is detached from the power station 200, as shown in FIG. 2, the power output terminal unit 250 and the power input terminal unit 260 are disconnected.

It is appreciated that the plurality of rechargeable batteries 221 of the high-capacity rechargeable battery pack 220 configured to supply electric power to the high-power demand functional unit 102, such as the sterilization and deodorization apparatus 33, can also be arranged to supply electric power of the low-power demand functional unit 101, such as the induction circuit 13 and the lid opening and closing device 14, so that the functional trash container 100 does not require to arrange any AC power supply configuration nor to contain low-power capacity battery. The user may replace the drained power station 200 with a charged power station 200 by detaching the trash container 100 from the drained power station 200 and resituate the trash container 100 on another replacement power station 200.

According to the preferred embodiment, the trash container may comprise a low-capacity battery pack 300 contained in the container lid 1 to supply power to the low-power functional unit 101, such as the induction circuit 13 and the lid opening and closing device 14. In particular, the low-capacity battery pack 300, including at least one battery, is provided in the trash container 100 to supply electrical power to the low-power demand functional unit 101 of the trash container 100 while the power station 200 supplies electrical power to the high power demand functional unit 102 of the trash container 100 via the power output terminal unit 250 and the power input terminal unit 260. The advantage of this embodiment is that when the power station 200 is drained, the user may simply detach the trash container 100 from the power station 200 and move the drained power station 200 to recharge through the power supply terminal unit 240. In the meanwhile, the low-power demand functional unit 101, such as the induction circuit 13 and the lid opening and closing device 14, is still functioning due to the continuous power supply by the low-capacity battery pack 300. The user may replace a fully charged power station 200 to the same location for the trash container 100 docking thereon to continue the power supply to the high-power demand functional unit 102 of the trash container 100.

It is appreciated that the trash container 100 is adapted to situate on the power station 200 which forms a stable base for the trash container 100, wherein the shape and size of the docking site 212 of the power station 200 matches the shape and size of the docking surface 110 which is the bottom surface of the container body 2 of the trash container 100.

In order to ensure the electrical connection between the power output terminal unit 250 and the power input terminal unit 260 is completely and precisely, it is preferred to arrange the docking of the docking surface 110 of the trash container 100 and the docking site 212 of the power station 200 in a coaxial manner. According to the preferred embodiment, the connection of the power output terminal unit 250 and the power input terminal unit 260 is a protrusion and indention fitting connection, that not only facilitates an alignment of the connection between the power output terminal unit 250 and the power input terminal unit 260, but also ensures a secure and stable electrical connection between the power output terminal unit 250 and the power input terminal unit 260.

Referring to FIG. 5 and FIG. 6, the power outlet terminal unit 250 is protruded at a center position of the docking site 212 on top of the housing 210 of the power station 200 and includes a ring-shaped inner power output first pole terminal 251 defining a circular center socket 253 and a larger outer power output second pole terminal 252 coaxially surrounding the inner power output first pole terminal 251. Correspondingly, the power inlet terminal unit 260 is indented in a center position of the docking surface 110 on the bottom of the container body 2 of the trash container 100 and comprises a circular inner power input first pole terminal 261 and a ring-shaped outer power input second pole terminal 262, defining a ring shape connection socket 263 therebetween. The power input first pole terminal 261 has a diameter fitting with the center socket 252 of the power outlet terminal unit 250 and the power output second pole terminal 252 has an outer diameter fitting with a diameter of the connection socket 263. Accordingly, the power output terminal unit 250 and the power input terminal unit 260 are fittingly connected with each other by inserting the power outer second pole terminal 252 into the connection socket 262 while the input first pole terminal 261 is inserted into the center socket 252 correspondingly, such that the input first pole terminal 261 is electrically connected to the output first pole terminal 251 and the input second pole terminal 262 is electrically connected to output second pole terminal 252.

It is worth mentioning that the output first pole terminal 251 and the input first pole terminal 261 can be the positive electric electrodes and the output second pole terminal 252 and the input second pole terminal can be the negative electric electrodes, vice versa.

It view of above, both the power output terminal unit 250 and the power input terminal unit 260 are configured in circular configuration so as to ensure an effective electric connection between the power output terminal unit 250 and the power input terminal unit 260 due to the weight of the trash container 100.

Referring to FIG. 5, FIG. 7 and FIG. 17, according to the preferred embodiment, in order to ensure the power outlet terminal unit 250 exposed outside will only supply electric power when the trash container 100 correctly docks on the docking site 212 and will not supply electric power when no trash container 100 is docked thereon nor being electrically connected with any other metal element when it stays alone, the high-capacity rechargeable battery package 220 is preferred to be arranged disconnecting with the power outlet terminal unit 250.

Accordingly, the power station 200 further comprises a trigger switch 270, which can be embodied a mechanical switch, a photoelectric switch or magnetic induction switch and is provided on the docking site 212 thereof for controlling an output of the plurality of rechargeable batteries 221 via the power output terminal unit 250 and configured in such a manner that only when both the power input terminal unit 260 at the docking surface 110 of the trash container 100 is correctly connected with the power output terminal unit 250 and the trigger switch 270 is actuated while the docking surface 110 docked on the docking site 212 presses against the trigger switch 270, the actuated trigger switch 270 sends a trigger signal to the control unit 230 to activate the plurality rechargeable batteries 221 of the rechargeable battery pack 220 to supply electric power to the trash container 100 via the power output terminal unit 250 and the power input terminal unit 260 to ensure a safety of the use of the rechargeable battery pack 220. Without the actuation of the trigger switch 270, i.e. the docking surface 110 is correctly docked on the docking site 212, even the power output terminal unit 2 of the power station 200 detached from trash container 100 is in contact with an electrical conducting material, no electric power will be supplied. In other words, the power station 200 of the present invention will only supply electric power when the docking surface 110 of the trash container 100 is correctly docked on the docking site 212 of the power station 200.

Referring to FIG. 7, the housing 210 of the power station 200 has an opening 212 communicating the station chamber 211 without outside for installing or replacing the high-power capacity rechargeable battery pack 220 and the control unit 230 in the station chamber 211, and comprises a station cover 213 configured to sealingly cover the opening 212.

In one embodiment, the power station further comprises at least one positioning member protruded on the docking site thereof and, correspondingly, at least one positioning groove is formed in the docking surface of the trash container, so as for guiding and aligning the docking surface to dock on docking site of the power station precisely when the trash container situates on the power station to ensure good and effective connection of the power output terminal unit and the power input terminal unit.

Preferably, the power supply terminal unit 240 is embodied as a power socket to ensure safety during charging of the high-capacity rechargeable battery pack 220.

It is appreciated that the power station 200 is configured to also charge the low-power battery 300 contained in the trash container 100 while the power output terminal unit 250 and the power input terminal unit 260 are electrically connected. Therefore, no additional power supply terminal is required to be provided by the trash container 100 to charge the low-power battery 300.

Since the high-power capacity rechargeable battery pack 220 is relatively heavy for its, for example, lithium-ion rechargeable batteries, the power station 200 further comprises one or more movable elements 280, which are embodied as roller wheels 281 rotatably mounted on a bottom of the housing 210 of the power station 200, for facilitating the ground transportation of the power station 200. Accordingly, the user may simply detach the trash container 100 from the drained power station 200 and roll another fully charged power station 200 here for the trash container 100 docking thereon. Then, the drained power station 200 can be rolling somewhere near the external power supply for recharging. The operation can be done in seconds.

Referring to FIG. 5 to FIG. 7, the power station 200 further comprises a docking alignment unit 290 configured to fittingly situate the docking surface 110 with the docking site 212 and precisely align the power output terminal unit 250 with the power input terminal unit 260 to ensure precise and fully electrical connection therebetween.

The docking alignment unit 290 of the power station 200 comprises at least one positioning member 291 protruded on the docking site 212 thereof and, correspondingly, at least one positioning groove 292 is formed in the docking surface 110 of the trash container 100 and configured to allow the at least one positioning member 291 fittingly embedded therein, so as for guiding and aligning the docking surface 110 to dock on docking site 212 of the power station 200 precisely when the trash container 100 situates on the power station 200 to ensure good and effective connection of the power output terminal unit 250 and the power input terminal unit 260.

In other embodiment, the docking alignment unit 290 can be embodied as magnetic attracting configuration, which comprises a first positioning magnet 291′ provided on the docking site 212 and a second positioning magnet 292′ provided on the docking surface 100 at a position corresponding to the a position of the fist positioning magnet 291′, so as to guide and align the docking surface 110 to dock on docking site 212 of the power station 200 precisely when the trash container 100 situates on the power station 200.

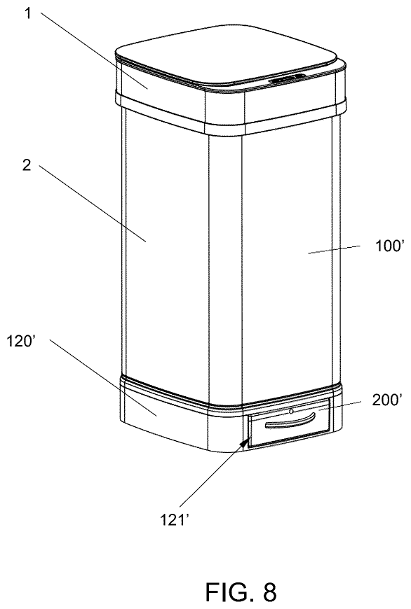

Referring to FIG. 8 to FIG. 12, a first alternative mode of the above preferred embodiment according to the present invention is illustrated, wherein the power station 200′ has the same structure as the above preferred embodiment, except the following differences.

The functional trash container 100′ of the first alternative mode comprises a container base 120′ underneath the container body 2 of the trash container 100′, wherein the container base 120′ has a station slot 121′ shaped and sized to allow the power station 200′ fittingly embedded therein. Further, the docking site 212′ of the power station 200′ is provided on a rear side thereof and docking surface 110′ forms at a rear end surface of the station slot 121′.

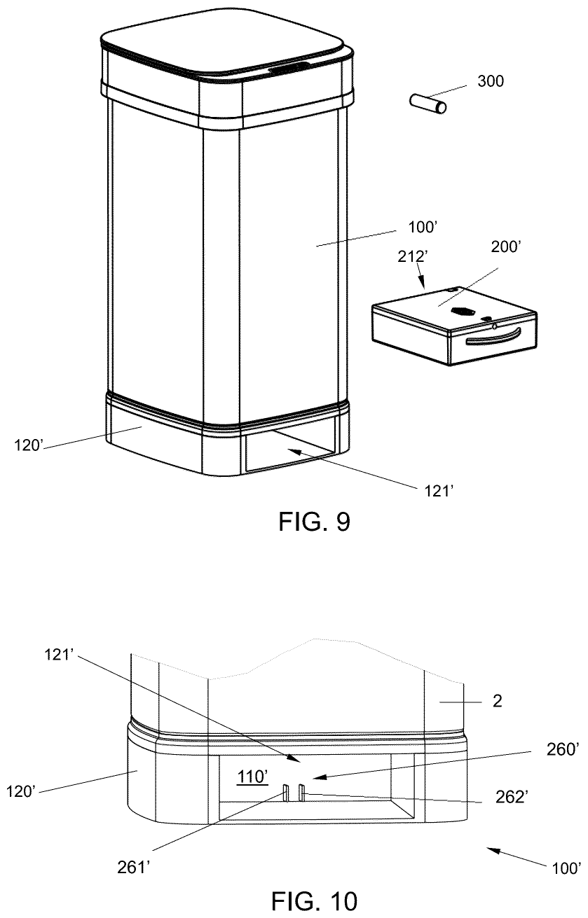

Referring to FIG. 10 and FIG. 12, the power output terminal unit 250′ is configured on the docking site 212′ and the output first pole terminal 251′ and the output second pole terminal 252′ thereof are embodied as a pair of positive and negative electric electrodes arranged in parallel manner. Correspondingly, the power input terminal unit 260′ is configured on the docking surface 110′ and the input first pole terminal 261′ and the input second pole terminal 262′ thereof are also embodied as a pair of positive and negative electric electrodes arranged in parallel manner, such that when the power station 200′ is embedded in the station slot 121′, the docking site 212′ docks against the docking surface 110′ and ensures the power output terminal unit 250′ provided on the docking site 212′ fully connected with the power input terminal unit 260′ provided on the docking surface 110′ of the container base 120′ of the trash container 100′.

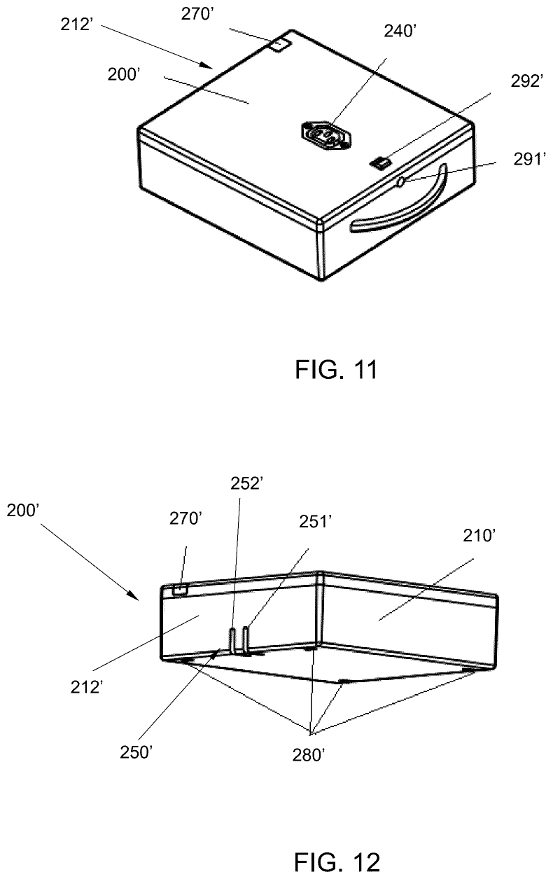

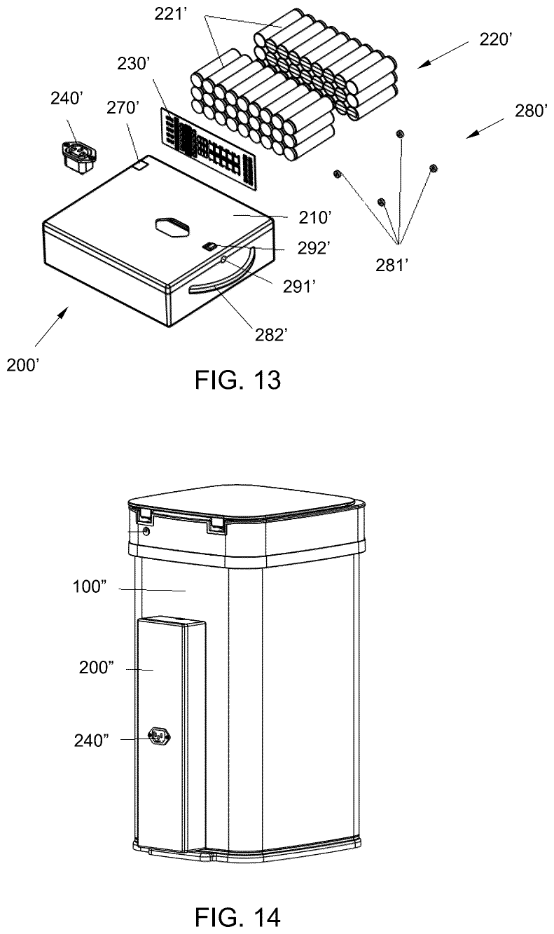

Referring to FIG. 11 and FIG. 13, the trigger switch 270′ of the power station 200′ according to the first alternative mode, which can be embodied as a mechanical switch, a photoelectric switch or magnetic induction switch, is arranged at the top rear edge of the housing 210′ of the power station 200′, such that when the power station 200′ is correctly embedded in the station slot 121′ by fully inserted into the station slot 121′, the trigger switch 270′ is actuated by the docking surface 110′ to send a signal to the control unit 230′ in the power station 200′ to activate the plurality rechargeable batteries 221′ of the rechargeable battery pack 220′ in the power station 200′ to supply electric power to the trash container 100′ via the power output terminal unit 250′ and the power input terminal unit 260′.

The power supply terminal unit 240′ is provided on the power station 200′. Similarly, the one or more movable elements 280′ are also embodied as roller wheels 281′ rotatably mounted on the bottom of the housing 210′ of the power station 200′. Beside the roller wheels, one of the movable elements 280′ is embodied as a handle 282′ provided on a front side of the housing 210′ for ease of hand carrying.

In addition, in order to ensure the safety of the power station 200′ while convenient charging, in terms of mechanical structure, the power station 200′ according to the first alterative mode of the above preferred embodiment further comprises an anti-detachment button 291′ and an anti-detachment buckle 292′ arranged on the housing 210′, wherein when the power station 200′ is embedded in the station slot 121′ in place, the anti-detachment buckle 292′ is automatically locked with the housing base 120′ for preventing the power station 200′ from falling off accidently. When the power station 200′ needs to be detached from the trash container 100′, the anti-detachment button 291′ should be pressed down first to disengage the locking of the anti-detachment buckle 292′. Then, the power station 200′ can be pulled out from the station slot 121′.

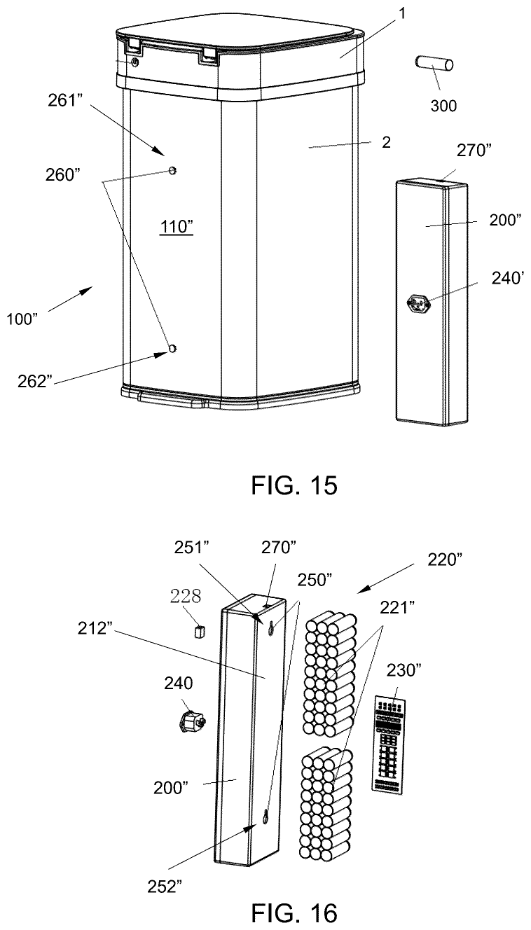

Referring to FIG. 14 to FIG. 16, a second alternative mode of the above preferred embodiment according to the present invention is illustrated, wherein the power station 200″ has the same structure as the above preferred embodiment except the following differences.

The docking surface 110″ of the functional trash container 100″ of the second alternative mode is the rear side surface thereof, wherein the input first pole terminal 261″ and thee input second pole terminal 262″ of the power input terminal unit 260″ are spacedly provided on the docking surface 110″. The power station 200″ is embodied to have a rectangular shape which rear side is embodied as the docking site 212′, wherein the output first pole terminal 251″ and the output second pole terminal of the power output terminal unit 250″ are spacedly provided on the docking site 212′ corresponding to the power input terminal unit 260″. The input first pole terminal 261″ and the input second pole terminal 262″ are embodied as a pair of positive and negative electric electrode protruding studs in spaced manner and the output first pole terminal 251′ and the output second pole terminal 252′ thereof are embodied as a pair of positive and negative electric electrode sockets correspondingly, such that when the power station 200″ is mounted on the container body 2 of the trash container 100″ by inserting the pair of positive and negative electric electrode protruding studs 261″, 262″ in the pair of the positive and negative electric electrode sockets 251″, 252″ so as to dock the docking site 212″ with the docking surface 110″, the power output terminal unit 250′ is fully connected with the power input terminal unit 260′ electrically.

The trigger switch 270″ of the power station 200″ according to the second alternative mode, which can be embodied as a mechanical switch, a photoelectric switch or magnetic induction switch, is arranged at the top rear edge of the housing 210′ of the power station 200″, such that when the docking site 212″ of the power station 200′ is correctly docked against the docking surface 110″, the trigger switch 270′ is actuated by the docking surface 110″ to send a signal to the control unit 230″ in the power station 200″ to activate the plurality rechargeable batteries 221″ of the rechargeable battery pack 220″ in the power station 200″ to supply electric power to the trash container 100″ via the power output terminal unit 250″ and the power input terminal unit 260″.

According to the above preferred embodiment and its alternative modes, the power station 200, 200″, 200″ is especially useful to equip with functional trash container 100, 100′, 100″ with high power demand, such as a sterilization and deodorization trash container that is required to be thorough clean. The user may simply detach the functional trash container 100, 100′, 100″ from the power station 200, 200′, 200″ without lifting and moving the heavy batteries 221, 221′, 221″ contained in the power station 200, 200′, 200″. In addition, since the power supply batteries 221, 221′, 221″ are not housed in the trash container 100, 100′, 100″, the cleaning of the trash container 100, 100′, 100″ can perfectly prevent the batteries 221, 221′, 221″ from getting wet, that may result in rapid discharge and potential overheating and damages of the batteries 221, 221′, 221″ as well as corrosion and internal chemical leakage of the batteries 221, 221′, 221″. Especially, to the lithium-ion or lithium polymer batteries, water can cause internal short circuits, leading to overheating, fire or even explosions due to phenomenon called thermal runaway. In other words, since the power station 200, 200′, 200″ is physically isolated from the receiving chamber 21 of the trash container 100, 100′, 100″ that may contain liquid waste, wet trash and organic waste, the risk of charging web batteries is avoided.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A power station for a trash container which comprises a low-power demand functional unit and a high-power demand functional unit, wherein the power station comprises:
a housing defining a station chamber therein and having a docking site on one side thereof adapted for a docking surface of the trash container docking thereto;
a high-capacity rechargeable battery pack, including a plurality of rechargeable batteries, being housed in the station chamber of the housing;
a control unit housed in the power chamber and configured to control the charging and discharging electric power of the plurality of rechargeable batteries, and converting a low voltage power of the plurality of rechargeable batteries to a high voltage power adapted for powering the high-power demand functional unit;
a power supply terminal electrically connected with the plurality of rechargeable batteries and the control unit for selectively connecting with an external power supply to charge the plurality of rechargeable batteries;
a power output terminal unit provided on the docking site and electrically connected with the plurality of rechargeable batteries and the control unit; and
a power input terminal unit adapted to be provided to the docking surface provided on the trash container and electrically connected with the high-power demand functional unit of the trash container, such that when the trash container is docked on power station, the power input terminal unit on the docking surface situated on the docking site of the power station is electrically connected with the power output terminal unit to supply electric power from the plurality of rechargeable batteries of the power station to the high-power demand functional unit of the trash container, and that when the trash container is detached from the power station, the power output terminal unit and the power input terminal unit are disconnected.

2. The power station, as recited in claim 1, further comprising one or more movable elements configured for facilitating a ground transportation of the power station.

3. The power station, as recited in claim 2, further comprising a docking alignment unit configured to fittingly situate the docking surface with the docking site and precisely align the power output terminal unit with the power input terminal unit to ensure precise and fully electrical connection therebetween.

4. The power station, as recited in claim 1, further comprising a trigger switch provided on the docking site thereof for controlling an output of the plurality of rechargeable batteries via the power output terminal unit and configured in such a manner that only when both the power input terminal unit at the docking surface of the trash container is correctly connected with the power output terminal unit and the trigger switch is actuated, the plurality rechargeable batteries of the rechargeable battery pack is activated to supply electric power to the trash container.

5. The power station, as recited in claim 1, wherein the housing, having a shape and size according to a shape and size of the docking surface, has a station chamber defined therein and the docking site is formed on one side thereof adapted for the docking surface of the trash container docking thereto.

6. The power station, as recited in claim 5, wherein the docking site is provided on a top side of the housing and the docking surface is provided on a bottom surface of the trash container, such that the power station forms a stable base for the trash container to situate thereon while the docking surface docking on the docking site and the power output terminal unit is electrically connected with the power input terminal unit.

7. The power station, as recited in claim 6, wherein the power outlet terminal unit is protruded at a center position of the docking site and includes a ring-shaped inner power output first pole terminal defining a circular center socket and a larger outer power output second pole terminal coaxially surrounding the inner power output first pole terminal, wherein the power inlet terminal unit is indented in a center position of the docking surface and comprises a circular inner power input first pole terminal and a ring-shaped outer power input second pole terminal, defining a ring shape connection socket therebetween, wherein the power input first pole terminal has a diameter fitting with the center socket of the power outlet terminal unit and the power output second pole terminal has an outer diameter fitting with a diameter of the connection socket, such that the power output terminal unit and the power input terminal unit are fittingly connected with each other by inserting the power outer second pole terminal into the connection socket while the input first pole terminal is inserted into the center socket correspondingly, such that the input first pole terminal is electrically connected to the output first pole terminal and the input second pole terminal is electrically connected to output second pole terminal.

8. The power station, as recited in claim 4, wherein the housing, having a shape and size according to a shape and size of the docking surface, has a station chamber defined therein and the docking site is formed on one side thereof adapted for the docking surface of the trash container docking thereto.

9. The power station, as recited in claim 8, wherein the docking site is provided on a top side of the housing and the docking surface is provided on a bottom surface of the trash container, such that the power station forms a stable base for the trash container to situate thereon while the docking surface docking on the docking site and the power output terminal unit is electrically connected with the power input terminal unit.

10. The power station, as recited in claim 9, wherein the power outlet terminal unit is protruded at a center position of the docking site and includes a ring-shaped inner power output first pole terminal defining a circular center socket and a larger outer power output second pole terminal coaxially surrounding the inner power output first pole terminal, wherein the power inlet terminal unit is indented in a center position of the docking surface and comprises a circular inner power input first pole terminal and a ring-shaped outer power input second pole terminal, defining a ring shape connection socket therebetween, wherein the power input first pole terminal has a diameter fitting with the center socket of the power outlet terminal unit and the power output second pole terminal has an outer diameter fitting with a diameter of the connection socket, such that the power output terminal unit and the power input terminal unit are fittingly connected with each other by inserting the power outer second pole terminal into the connection socket while the input first pole terminal is inserted into the center socket correspondingly, such that the input first pole terminal is electrically connected to the output first pole terminal and the input second pole terminal is electrically connected to output second pole terminal.

11. The power station, as recited in claim 1, wherein the docking site is provided on a rear side of the housing while the docking surface is a rear end surface of a station slot formed in a container base of the trash container.

12. The power station, as recited in claim 11, wherein the power output terminal unit comprises an output first pole terminal and an output second pole terminal provided on the docking site in parallel manner and, correspondingly, the power input terminal unit comprises an input first pole terminal and an input second pole terminal provided on the docking surface in parallel manner, wherein the output first pole terminal and the output second pole terminal thereof are a pair of positive and negative electric electrodes arranged in parallel manner, wherein the power input terminal unit is configured on the docking surface and the input first pole terminal and the input second pole terminal thereof are a pair of positive and negative electric electrodes arranged in parallel manner, such that when the power station is embedded in the station slot, the docking site docks against the docking surface and ensures the power output terminal unit provided on the docking site fully connected with the power input terminal unit provided on the docking surface of the container base of the trash container.

13. The power station, as recited in claim 3, wherein the docking site is provided on a rear side of the housing while the docking surface is a rear end surface of a station slot formed in a container base of the trash container.

14. The power station, as recited in claim 13, wherein the power output terminal unit comprises an output first pole terminal and an output second pole terminal provided on the docking site in parallel manner and, correspondingly, the power input terminal unit comprises an input first pole terminal and an input second pole terminal provided on the docking surface in parallel manner, wherein the output first pole terminal and the output second pole terminal thereof are a pair of positive and negative electric electrodes arranged in parallel manner, wherein the power input terminal unit is configured on the docking surface and the input first pole terminal and the input second pole terminal thereof are a pair of positive and negative electric electrodes arranged in parallel manner, such that when the power station is embedded in the station slot, the docking site docks against the docking surface and ensures the power output terminal unit provided on the docking site fully connected with the power input terminal unit provided on the docking surface of the container base of the trash container.

15. The power station, as recited in claim 12, further comprising a trigger switch which is arranged at a top rear edge of the housing, such that when docking site is correctly docked against the docking surface, the trigger switch is actuated by the docking surface to activate the plurality rechargeable batteries of the rechargeable battery pack to supply electric power to the trash container via the power output terminal unit and the power input terminal unit.

16. The power station, as recited in claim 15, further comprising a trigger switch which is arranged at a top rear edge of the housing, such that when the power station is correctly embedded in the station slot by fully inserted into the station slot, the trigger switch is actuated by the docking surface to activate the plurality rechargeable batteries of the rechargeable battery pack to supply electric power to the trash container via the power output terminal unit and the power input terminal unit.

17. The power station, as recited in claim 1, wherein the docking surface is a rear side surface of the trash container, wherein the power output terminal unit comprises an output first pole terminal and an output second pole terminal spacedly provided on the docking site and the power input terminal comprises an input first pole terminal and an input second pole terminal spacedly provided on the docking surface correspondingly.

18. The power station, as recited in claim 17, wherein the input first pole terminal and the input second pole terminal are a pair of positive and negative electric electrode protruding studs in spaced manner and the output first pole terminal and the output second pole terminal thereof are a pair of positive and negative electric electrode sockets correspondingly, such that when the power station is mounted on the trash container by inserting the pair of positive and negative electric electrode protruding studs in the pair of the positive and negative electric electrode sockets so as to dock the docking site with the docking surface while the power output terminal unit is fully connected with the power input terminal unit electrically.

19. The power station, as recited in claim 18, further comprising a tripper switch which is arranged at a top rear edge of the housing, such that when docking site is correctly docked against the docking surface, the trigger switch is actuated by the docking surface to activate the plurality rechargeable batteries of the rechargeable battery pack to supply electric power to the trash container via the power output terminal unit and the power input terminal unit.

20. The power station, as recited in claim 3, further comprising a trigger switch, wherein the docking surface is a rear side surface of the trash container, wherein the power output terminal unit comprises an output first pole terminal and an output second pole terminal spacedly provided on the docking site and the power input terminal comprises an input first pole terminal and an input second pole terminal spacedly provided on the docking surface correspondingly, wherein the input first pole terminal and the input second pole terminal are a pair of positive and negative electric electrode protruding studs in spaced manner and the output first pole terminal and the output second pole terminal thereof are a pair of positive and negative electric electrode sockets correspondingly, such that when the power station is mounted on the trash container by inserting the pair of positive and negative electric electrode protruding studs in the pair of the positive and negative electric electrode sockets so as to dock the docking site with the docking surface while the power output terminal unit is fully connected with the power input terminal unit electrically, wherein the trigger switch is arranged at a top rear edge of the housing, such that when docking site is correctly docked against the docking surface, the trigger switch is actuated by the docking surface to activate the plurality rechargeable batteries of the rechargeable battery pack to supply electric power to the trash container via the power output terminal unit and the power input terminal unit.
